(19) United States
(12) Patent Application Publication
(10) Pub. No.: US 2025/0252743 A1
(43) Pub. Date: Aug. 7, 2025

(54) STANDBY MODE FOR MONITORING VEHICLE SURROUNDINGS

(71) Applicant: Toyota Motor Engineering & Manufacturing North America, Inc., Plano, TX (US)

(72) Inventor: Shaurya Panthri, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/431,806

(22) Filed: Feb. 2, 2024

(51) Int. Cl. G06V 20/52; B60W 50/14; G06F 1/3296; H04W 4/02

(52) U.S. Cl. CPC G06V 20/52; B60W 50/14; G06F 1/3296; H04W 4/02; B60W 2420/403; B60W 2420/54

(57) ABSTRACT

Methods, systems, and apparatus for a vehicle monitoring system. The vehicle monitoring system includes one or more sensors configured to capture sensor data of a surrounding environment and an electronic control unit in electronic communication with the sensor(s). When the vehicle parks, the system receives location data regarding the vehicle's current location. Based on the location of the vehicle, the system determines whether the vehicle's monitoring system should be operated in a full perception mode or standby mode. Full perception mode corresponds to all sensors of the vehicle operating at full capacity (e.g., at the highest available frame rate) to monitor the surroundings of the vehicle. Standby mode corresponds to minimal sensor operation, which may correspond to less than all sensors monitoring the surroundings of the vehicle, the least energy-consuming sensors operating (e.g., ultrasound sensors as opposed to cameras), sensors operating at a lower frame rate, etc.

### BACKGROUND

### Field

This disclosure relates to monitoring any unusual or suspicious activities near or directed at a parked vehicle.

### Description of the Related Art

Vehicle monitoring systems use vehicle sensors to monitor the surroundings of a vehicle for crime. However, some monitoring systems can use a significant amount of vehicle energy to operate the sensors of the vehicle. If the monitoring system uses too much energy while the vehicle is parked, the vehicle can be at risk of being depleted of energy such that the vehicle is unable to start or the range of the vehicle is significantly reduced.

Accordingly, there is a need for a system and method for monitoring activities surrounding the vehicle in an energy efficient manner.

### SUMMARY

In general, one aspect of the subject matter described in this disclosure may be embodied in a monitoring system for a vehicle. The monitoring system includes a first vehicle sensor configured to capture a first sensor data of a surrounding environment, the first vehicle sensor is configured to be powered on when the monitoring system is in a standby mode. The monitoring system further includes a second vehicle sensor configured to capture a second sensor data of the surrounding environment, the second vehicle sensor is configured to be powered on when the monitoring system is in a full perception mode and powered off when the monitoring system is in the standby mode. The monitoring system further includes an electronic control unit coupled to the first sensor and the second sensor. The electronic control unit is configured to receive location data of the vehicle and operate the first vehicle sensor in the standby mode when the vehicle is parked based upon the location data of the vehicle.

These and other embodiments may optionally include one or more of the following features. The electronic control unit can be further configured to determine whether the vehicle is parked in a predetermined location, and, in response to determining that the vehicle is parked in the predetermined location, activate the standby mode. The electronic control unit can be further configured to determine whether the vehicle is parked in a predetermined location, and, in response to determining that the vehicle is not parked in the predetermined location: (i) activate the full perception mode, and/or (ii) send a notification to a user device prompting a user to select between the standby mode or the full perception mode.

In various embodiments, the electronic control unit is further configured to determine a state of charge of a power source of the vehicle, and in response to detecting the state of charge being less than a predetermined value, send the notification to the user device prompting the user to (i) select between the standby mode or the full perception mode, and/or (ii) charge the power source.

In various embodiments, the electronic control unit is configured to select between the standby mode and the full perception mode further based upon a weather condition at a location of the vehicle, a state of charge of a power source of the vehicle, a distance from the vehicle to a vehicle charging station, a perceived level of threat at the location of the vehicle, and/or real-time traffic data.

In various embodiments, the first vehicle sensor includes a plurality of external sensors that are configured to capture different views of the surrounding environment outside the vehicle. In various embodiments, the first vehicle sensor includes an ultrasonic sensor. In various embodiments, the second vehicle sensor includes a plurality of external sensors that are configured to capture different views of the surrounding environment outside the vehicle. In various embodiments, the second vehicle sensor includes a camera.

In another aspect, the subject matter may be embodied in a method for monitoring vehicle surroundings. The method includes receiving, by a monitoring system of a vehicle, location data indicating a current location of the vehicle. The method further includes operating the monitoring system of the vehicle based upon the location data. The method further includes, in response to the location data indicating the vehicle located in a first location, operating the monitoring system in a standby mode. The method further includes, in response to the location data indicating the vehicle located in a second location, operating the monitoring system in a full perception mode.

These and other embodiments may optionally include one or more of the following features. In various embodiments, power consumption of the monitoring system is less in the standby mode than in the full perception mode. In various embodiments, the operating the monitoring system in the standby mode includes powering on a first plurality of vehicle sensors and powering off a second plurality of vehicle sensors. In various embodiments, the operating the monitoring system in the full perception mode includes powering on the second plurality of vehicle sensors.

In various embodiments, the method further includes detecting that the vehicle is in park, and operating the monitoring system of the vehicle based upon the location data while the vehicle is in park.

In various embodiments, the location data further includes a weather condition at a location of the vehicle, a state of charge of a power source of the vehicle, a distance from the vehicle to a vehicle charging station, a perceived level of threat at the location of the vehicle, and/or real-time traffic data.

In various embodiments, the method further comprises detecting unusual activity with the monitoring system in the standby mode, and, in response thereto, at least one of switching from the standby mode to the full perception mode or sending a notification to a user device prompting a user to select between the standby mode or the full perception mode.

In various embodiments, the method further comprises using one or more ultrasonic sensors when operating the monitoring system in the standby mode, and using one or more cameras when operating the monitoring system in the full perception mode.

In another aspect, the subject matter may be embodied in a monitoring system for a vehicle, including a vehicle sensor of a first vehicle configured to capture a sensor data of a surrounding environment of the first vehicle and an electronic control unit coupled to the vehicle sensor. The electronic control unit is configured to receive surrounding environment data from a second vehicle parked adjacent the first vehicle, and power on the vehicle sensor based upon the surrounding environment data received from the second vehicle.

These and other embodiments may optionally include one or more of the following features. In various embodiments, the electronic control unit is further configured to activate full perception mode of the first vehicle in response to the surrounding environment data indicating suspicious activity. In various embodiments, the first vehicle is an electric vehicle and the second vehicle is an internal combustion engine vehicle. In various embodiments, the second vehicle is a lead vehicle and/or a tow vehicle and the first vehicle is a follow vehicle and/or a towed vehicle.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is a block diagram of an example monitoring system according to an aspect of the invention.

FIG. 2 shows an example illustration of the positioning of one or more external sensors of the monitoring system of FIG. 1 on the vehicle according to an aspect of the invention.

FIG. 3 is a flow diagram of an example process for monitoring vehicle surroundings using the monitoring system of FIG. 1 according to an aspect of the invention.

FIG. 4 is a block diagram of an example monitoring system utilizing two vehicles according to an aspect of the invention.

FIG. 5 is a flow diagram of an example process for monitoring vehicle surroundings using the monitoring system of FIG. 4 according to an aspect of the invention.

### DETAILED DESCRIPTION

Disclosed herein are systems, vehicles, and methods for improving vehicle monitoring. Particular embodiments of the subject matter described in this disclosure may be implemented to realize one or more of the following advantages. The unusual or suspicious activities detection, recording, and reporting system (“monitoring system”) detects, records, and/or reports unusual or suspicious activities (“unusual activity”) that occur around, in proximity, and/or within the external environment of the vehicle. The monitoring system controls a vehicle to operate in a standby mode when full operation of the vehicle's sensors is not necessary to monitor the vehicle's surroundings, thereby improving energy efficiency.

The monitoring system can adapt to different environmental factors and/or circumstances of the environment. The monitoring system can utilize a Global Positioning System (GPS) unit for detecting location data including a current location of the vehicle to determine a threat level of the surrounding environment. In this manner, the monitoring system may account for various environmental factors, such as the time of day, the location, the weather, and/or other factors, in determining the threat level. This allows for a more precise and accurate understanding of different threat levels at different locations, times of day, etc. to accurately determine whether full perception mode (or standby mode) is more appropriate.

Other benefits and advantages include the use of artificial intelligence including machine algorithm learning with models to anticipate, predict, or otherwise determine when an unusual activity occurs or is about to occur. By anticipating, predicting or otherwise determining when the unusual activity occurs or is about to occur, the monitoring system proactively anticipates the unusual activity and may act to prevent, report, or otherwise record or document the unusual activity. For example, the monitoring system may alert the police to apprehend a suspicious person and/or prevent any malicious activity. In another example, the monitoring system may alert the surrounding area in an attempt to prevent the malicious activity and/or record the malicious activity to mitigate consequences of the malicious activity, such as by providing a record of the malicious activity to identify the suspect and/or any damages. The monitoring system may learn from each instance of a potentially unusual activity.

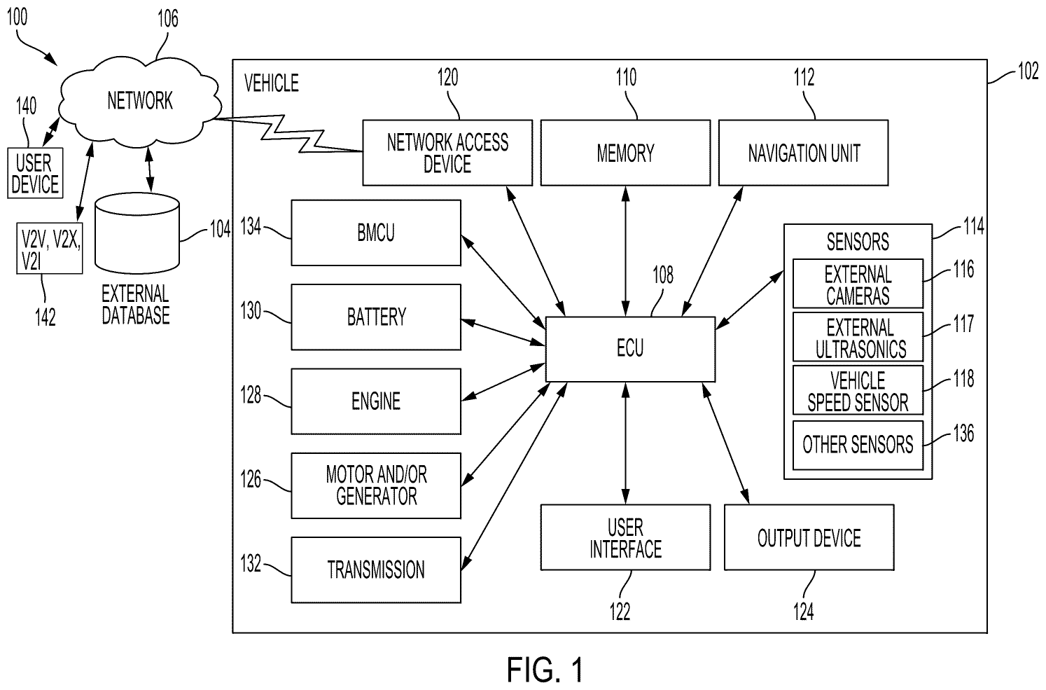

FIG. 1 is a block diagram of a monitoring system 100. The monitoring system 100 may be retro-fitted, coupled to, include or be included within a vehicle 102. The monitoring system 100 may couple, connect to, or include an external database 104. The monitoring system 100 may have a network 106 that links the external database 104 with the vehicle 102. The network 106 may be a local area network (LAN), a wide area network (WAN), a cellular network, the Internet, or combination thereof, that connects, couples and/or otherwise communicates between the vehicle 102 and the external database 104.

The monitoring system 100 detects, identifies, predicts, and/or anticipates unusual and suspicious activity that occurs and/or may potentially occur in the near future within or surrounding and/or inside the vehicle 102. The monitoring system 100 may use artificial intelligence including a machine learning algorithm to predict when an unusual object or action of the object may impact, damage or present a danger to the vehicle 102.

The monitoring system 100 may include or be retro-fitted or otherwise coupled with the vehicle 102. A vehicle 102 is a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, and/or a generator. Other examples of vehicles include bicycles, trains, planes, or boats, and any other form of conveyance that is capable of transportation. The vehicle 102a-b may be semi-autonomous or autonomous. That is, the vehicle 102 may be self-maneuvering and navigate without human input. An autonomous vehicle may have and use one or more sensors and/or a navigation unit to drive autonomously.

The monitoring system 100 includes one or more processors, such as an electronic control unit (ECU) 108 and a memory 110. The monitoring system 100 may include other components, such as a navigation unit 112, one or more sensors 114 including one or more external cameras 116, one or more external ultrasonic sensors 117, a vehicle speed sensor 118 and/or other sensors 136, a network access device 120, a user interface 122 and/or an output device 124. Other sensors 136 can include cameras, radars, ultrasonics, LiDAR, microphones, etc. The monitoring system 100 may couple, connect to, and/or include one or more vehicle components such as the motor and/or generator 126, the engine 128, the battery 130, the transmission 132 and/or the battery management control unit (BMCU) 134.

The ECU 108 may be implemented as a single ECU or as multiple ECUs. The ECU 108 may be electrically coupled to some or all of the other components within the vehicle 102, such as the motor and/or generator 126, the transmission 132, the engine 128, the battery 130, the battery management control unit (BMCU) 134, the memory 110, the network access device 120, and/or one or more sensors 114. The ECU 108 may include one or more processors or controllers specifically designed for predicting unusual activities within the surrounding environment of the vehicle 102 and within the vehicle. The unusual activities may be external to the vehicle 102. The ECU 108 may generate predictive models and use machine learning algorithms to anticipate unusual activities before the unusual activities occur.

An unusual or suspicious activity may be any object that is not normally within the external environment of the vehicle. That is, the object is not within the baseline representation or model of the environment, and thus, may be considered unusual, suspicious, or otherwise not normal. The unusual activity may also be an action or motion performed or about to be performed by an object that is not normal within the external environment of the vehicle. That is, the action of the object is not within the baseline representation, model or behavior expected of the object within the environment, and thus, may be considered unusual, suspicious, or otherwise not normal.

The ECU 108 may analyze the external environment of the vehicle 102 and compare the data to a baseline and/or input the data into a model to anticipate, predict or otherwise determine any unusual activities within the environment. If an unusual activity is predicted or otherwise detected, the ECU 108 may act to record, document, provide or otherwise act to mitigate consequences of the unusual activity. The ECU 108 may be coupled to a memory 110 and execute instructions that are stored in the memory 110.

The memory 110 may be coupled to the ECU 108 and store instructions that the ECU 108 executes. The memory 110 may include one or more of a Random Access Memory (RAM) or other volatile or non-volatile memory. The memory 110 may be a non-transitory memory or a data storage device, such as a hard disk drive, a solid-state disk drive, a hybrid disk drive, or other appropriate data storage, and may further store machine-readable instructions, which may be loaded and executed by the ECU 108. Moreover, the memory 110 may be used to record and store image data before, after and/or during the occurrence of the unusual activity to document the unusual activity.

The monitoring system 100 may include a user interface 122. The monitoring system 100 may display one or more notifications on the user interface 122. The one or more notifications on the user interface 122 may notify occupants of the vehicle when the monitoring system 100 is initialized or activated. The user interface 122 may include an input/output device that receives user input from a user interface element, a button, a dial, a microphone, a keyboard, or a touch screen. For example, the user interface 122 may receive user input that may include configurations as to the amount of sensor data or the length of the video to record when an unusual activity is detected. Other configurations may include a sensitivity to the surrounding environment as to when to trigger the activation of the external cameras 116, for example. The user interface 122 may provide an output to an output device, such as a display, a speaker, an audio and/or visual indicator, or a refreshable braille display. For example, the user interface 122 may playback recording on a user display.

The monitoring system 100 may include a network access device 120. The network access device 120 may include a communication port or channel, such as one or more of a Wi-Fi unit, a Bluetooth® unit, a radio frequency identification (RFID) tag or reader, or a cellular network unit for accessing a cellular network (such as 3G, 4G or 5G). The network access device 120 may transmit data to and receive data from the external database 104. For example, the ECU 108 may communicate with the external database 104 to obtain baseline models of activities and objects at a current location of the vehicle 102, via the network 106. The monitoring system 100 may use the baseline models to extrapolate the unusualness of an object, coupled object or motion of the object to anticipate, predict or determine unusual activities surrounding the vehicle 102.

The network access device 120 may transmit data to and receive data from a user device 140 (e.g., a smart phone, a tablet, a personal computer, etc.) located remotely from the vehicle 102. The monitoring system 100 may display one or more notifications on the user device 140, similar to user interface 122. Accordingly, the user device 140 can have a user interface whereby a user can communicate with the ECU 108 from a remote location.

The network access device 120 may transmit data to and receive data from other databases 142, for example using vehicle-to-vehicle (V2V) communication, vehicle-to-everything (V2X), and/or vehicle-to-infrastructure (V2I). For example, monitoring system 100 can enable vehicle 102 to exchange vehicle data with a second vehicle using V2V communication technology. Monitoring system 100 can receive location data such as traffic congestion, weather advisories, bridge clearance levels, traffic light status, and/or crime data to inform the monitoring system 100 of conditions at or near the location that the vehicle 102 is parked using V2I and/or V2X communication technology. Accordingly, the vehicle 102 may communicate with another vehicle or a network using vehicle-to-vehicle communications or vehicle-to-infrastructure communications via the network access device 120.

The monitoring system may include a navigation unit 112 and/or one or more sensors 114. The navigation unit 112 may be integral to the vehicle 102 or a separate unit coupled to the vehicle 102, such as a personal device with navigation capabilities. When the navigation unit 112 is separate from the vehicle 102, the navigation unit 112 may communicate with the vehicle 102 via the network access device 120. In some implementations, the vehicle 102 may include a GPS unit for detecting location data including a current location of the vehicle 102 and date/time information instead of the navigation unit 112. In that regard, the ECU 108 may perform the functions of the navigation unit 112 based on data received from the GPS unit. At least one of the navigation unit 112 or the ECU 108 may predict or propose a route set that includes a starting location and a destination location. The navigation unit 112 or the ECU 108 may perform navigation functions. Navigation functions may include, for example, route and route set prediction, providing navigation instructions, and receiving user input such as verification of predicted routes and route sets or destinations. Other information, such as a current speed of the vehicle 102, may be extrapolated, interpreted or otherwise calculated from the data obtained from the navigation unit.

The navigation unit 112 may provide and obtain navigational map information including location data, which may include a current location, a starting location, a destination location and/or a route between the starting location or current location and the destination location of the vehicle 102. The navigation unit 112 may include a memory (not shown) for storing the route data. The navigation unit 112 may receive data from other sensors capable of detecting data corresponding to location information. For example, the other sensors may include a gyroscope or an accelerometer.

The navigational map information may include entity information. The entity information may include locations or places of interest, such as government buildings, commercial businesses, schools, tourist attractions, or other places of interest. These different entities may be one factor in determining whether an object or an action of an object is unusual.

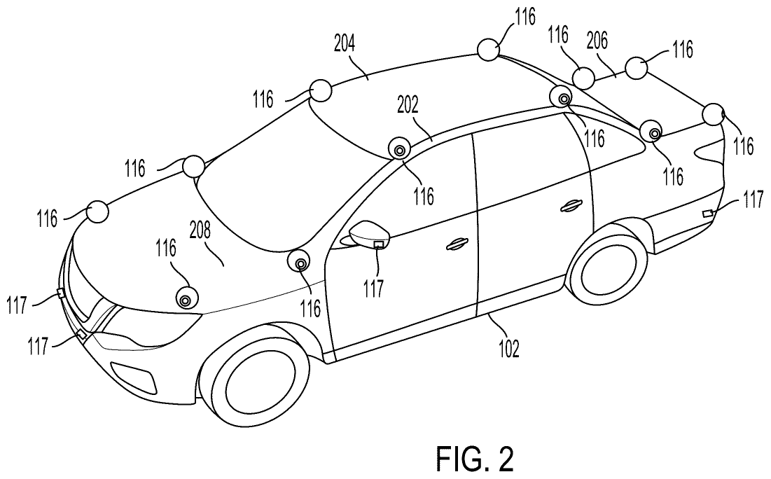

The one or more sensors 114 may include one or more external cameras 116, one or more external ultrasonic sensors, a vehicle speed sensor 118 and/or other sensors 136. The one or more external cameras 116 may include multiple cameras positioned on the outside of the vehicle 102 and/or within the vehicle 102 but directed outward to capture different views of the surrounding environment outside the vehicle 102, as shown in FIG. 2 for example. The one or more external cameras 116 may be positioned along a frame 202 of the vehicle 102, such as along the roof 204, the trunk 206, or the front 208 of the vehicle 102. The positions of the external cameras 116 can vary depending on the type of vehicle, among other factors. The different views of the surrounding environment may be used to form a panoramic or 360 degree image of the surrounding environment outside the vehicle 102, which allows the monitoring system 100 to capture any unusual activity outside the vehicle 102, such as an individual attempting to break into the vehicle 102. The one or more external cameras 116 may capture image data that includes a single frame or image or a continuous video of the surrounding environment outside the vehicle 102.

The one or more external ultrasonic sensors 117 may include multiple ultrasonic sensors positioned on the outside of the vehicle 102 and/or within the vehicle 102 but directed outward to capture different views of the surrounding environment outside the vehicle 102, as shown in FIG. 2 for example. The one or more external ultrasonic sensors 117 may be positioned along a frame 202 of the vehicle 102, such as along the roof 204, the trunk 206, or the front 208 of the vehicle 102. The different views of the surrounding environment may be used to form a panoramic or 360 degree field of view of the surrounding environment outside the vehicle 102, which allows the monitoring system 100 to capture any unusual activity outside the vehicle 102, such as an individual attempting to break into the vehicle 102.

The one or more sensors 114 may include a vehicle speed sensor 118. The vehicle speed sensor 118 may measure the amount of rotation of the multiple wheels to determine whether the vehicle 102 is stationary and/or parked. The one or more sensors 114 may include other sensors 136 to measure the road condition, the weather, the ambient lighting surrounding the vehicle 102 or other environmental factors that may be used to determine whether there is unusual activity.

The monitoring system 100 may include an output device 124. The output device 124 may be an audio indicator, a visual indicator, a communication device or other output device. The audio or visual indicator may be used to sound an alarm or flash an alarm, respectively, for example. The communication device may be used to contact the police, insurance company, or other entity and provide recordings to the police, insurance company, or other entity. The communication device may notify or provide documentation to the owner of the vehicle 102 that an unusual activity in proximity to the vehicle 102 is about to occur, has occurred, or is occurring.

The monitoring system 100 may couple, connect to, and/or include one or more vehicle components. The one or more vehicle components may include a motor and/or generator 126. The motor and/or generator 126 may convert electrical energy into mechanical power, such as torque, and may convert mechanical power into electrical energy. The motor and/or generator 126 may be coupled to the battery 130. The motor and/or generator 126 may convert the energy from the battery 130 into mechanical power, and may provide energy back to the battery 130, for example, via regenerative braking. In some implementations, the vehicle 102 may include one or more additional power generation devices such as the engine 128 or a fuel cell stack (not shown). The engine 128 combusts fuel to provide power instead of and/or in addition to the power supplied by the motor and/or generator 126.

The battery 130 may be coupled to the motor and/or generator 126 and may provide electrical energy to and receive electrical energy from the motor and/or generator 126. The battery 130 may include one or more rechargeable batteries.

The BMCU 134 may be coupled to the battery 130 and may control and manage the charging and discharging of the battery 130. The BMCU 134, for example, may measure, using battery sensors, parameters used to determine the state of charge (SOC) of the battery 130. The BMCU 134 may control the battery 130.

The one or more vehicle components may include the transmission 132. The transmission 132 may have different gears and/or modes, such as park, drive and/or neutral and may shift between the different gears. The transmission 132 manages the amount of power that is provided to the wheels of the vehicle 102 given an amount of speed.

The monitoring system 100 may include or be coupled to the external database 104. A database is any collection of pieces of information that is organized for search and retrieval, such as by a computer, and the database may be organized in tables, schemas, queries, reports, or any other data structures. A database may use any number of database management systems. The external database 104 may include a third-party server or website that stores or provides information. The information may include real-time information, periodically updated information, or user-inputted information. A server may be a computer in a network that is used to provide services, such as accessing files or sharing peripherals, to other computers in the network.

The external database 104 may be a relational database or behavioral model database that provides models of normal motions and/or features of different objects. The external database 104 may be updated and/or provide updates in real-time. The external database 104 may store and/or provide the models to the ECU 108. The external database 104 may also store environmental factors, such as weather information or time of day information, and provide the environmental factors to the ECU 108 to assist in determine whether an object or an action of the object is unusual or otherwise different from a baseline. The weather information may include the temperature, weather, road conditions, amount of precipitation and/or other weather factors that may affect the determination of an unusual activity. For example, when the weather is cold and there is precipitation, the monitoring system 100 is less likely to find a person in a bulky winter jacket with a scarf and other headwear that may cover their face unusual than when the weather is hot and humid. As another example, when the weather is cold, the state of charge of the battery 130 may decline more rapidly or the battery may be less inclined to charge than when the weather is warmer, which can be a trigger for the monitoring system to activate the standby mode.

Monitoring system 100 can be configured to operate in a first mode (e.g., a standby mode), where a limited number or type of sensors 114 are used, and a second mode (e.g., a full perception mode), where an additional number or type of sensor 114 is used. Full perception mode corresponds to all sensors of the vehicle operating at full capacity (e.g., at the highest available frame rate) to monitor the surroundings of the vehicle. Standby mode corresponds to minimal sensor operation, which may correspond to less than all sensors monitoring the surroundings of the vehicle, the least energy-consuming sensors operating (e.g., ultrasound sensors as opposed to cameras), sensors operating at a lower frame rate, etc. For example, in the standby mode, the monitoring system 100 can power on a first plurality of vehicle sensors, such as the external ultrasonic sensors 117, to monitor the surrounding environment. In the full perception mode, the monitoring system 100 can power on a second plurality of vehicle sensors, such as the external cameras 116, to monitor the surrounding environment. The ultrasonic sensors 117 can use less power than the external cameras 116. Accordingly, less power is used in the standby mode and the useful life of the battery 130 can be extended. Although described herein as using ultrasonic sensors 117 in the standby mode, and external cameras 116 in the full perception mode, it should be understood that any type of vehicle monitoring sensors can be used in the standby and/or full perception modes. However, in the standby mode the number and/or type of sensors 114 used by the monitoring system 100 are selected so that less power is used in the standby mode than in the full perception mode, thereby using less charge of the battery 130 and extending the range of the vehicle 102.

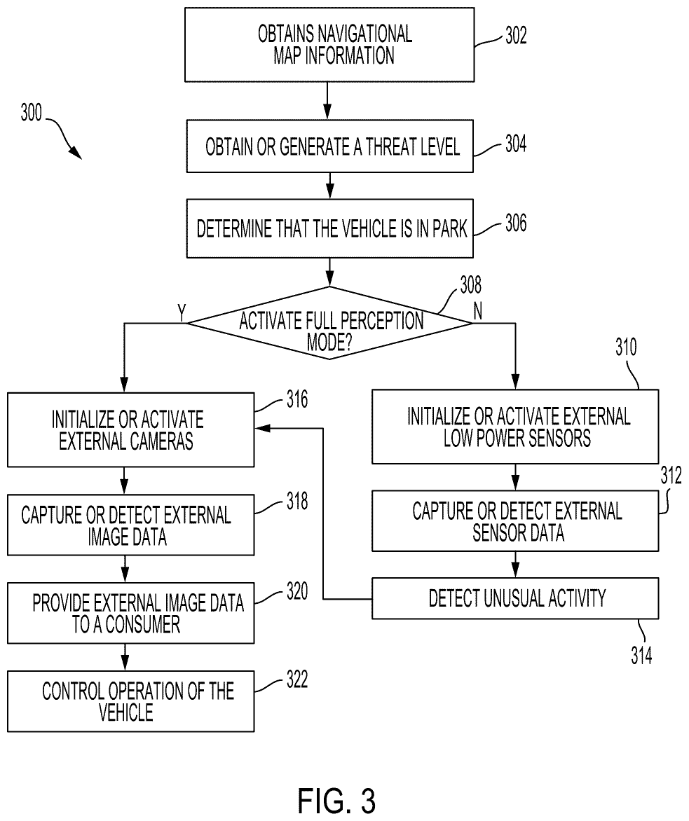

FIG. 3 is a flow diagram of an example process 300 for monitoring vehicle surroundings. One or more computers or one or more data processing apparatuses, for example, the ECU 108 of the monitoring system 100 of FIG. 1, appropriately programmed, may implement the process 300.

The monitoring system 100 obtains navigational map information (302). The monitoring system 100 may use the navigation unit 112 to obtain the navigational map information including a current location of the vehicle 102 and other entity information, such as places of interest in proximity or within a threshold distance of the vehicle 102. The monitoring system 100 may extract the current location and/or the other entity information from the navigational map information. For example, the monitoring system 100 may use a GPS system to determine the current location of the vehicle 102. In some implementations, the monitoring system 100 may provide the current location of the vehicle 102 to an external database 104 to obtain nearby entity information to identify different places of interest in proximity to the vehicle 102 and/or weather information.

Once the monitoring system 100 obtains the current location of the vehicle 102, the monitoring system 100 may obtain or generate a perceived threat level at the current location of the vehicle (304). The threat level can be based on a crime rate, or estimated crime rate, of the vehicle's location. The monitoring system 100 uses the perceived level of threat to determine whether to activate full perception mode for enhanced monitoring or low power, standby mode. The monitoring system 100 can obtain or generate the threat level based on the current location of the vehicle 102 and other environmental factors. For example, the monitoring system 100 can take into account crime-related data received from the external database 104. Crime-related data can include whether a crime has recently been committed in the area, whether a crime has recently been reported in the area, what times do crimes generally occur in that area, etc. If the vehicle is in a low-crime area with minimal break-ins, the monitoring system 100 can be configured to operate in the standby mode, absent other external factors that would cause the monitoring system 100 to operate in full perception mode. Similarly, if the vehicle is in a familiar location, such as a user's garage/driveway, the monitoring system 100 can be configured to operate in the standby mode. For example, the monitoring system 100 can store predetermined locations (e.g., at a user's work office, at a user's home, etc.) that are known to be safe and the monitoring system 100 can be configured to operate in the standby mode at these predetermined locations. If, on the other hand, the vehicle 102 is in a high-crime area or if a crime has just been committed nearby, the monitoring system 100 can be configured to operate in the full perception mode.

The monitoring system 100 may determine that the vehicle 102 is in park or otherwise not moving (306). The monitoring system 100 may use the vehicle speed sensor 118 to measure the speed of the vehicle 102 and may determine that the vehicle is in park when the speed is approximately 0 mph. In some implementations, the monitoring system 100 determines the gear that transmission 132 is in and may determine that the vehicle 102 is parked when the transmission 132 is in a locked state or in a park mode. In some implementations, the monitoring system 100 may determine that the engine and/or ignition is off, and thus, the vehicle 102 must be in park if the engine and/or the ignition is off.

When the vehicle 102 is parked, the monitoring system 100 may determine whether to monitor the vehicle's surroundings in the low power, standby mode or the full power, full perception mode (308). The monitoring system 100 can make this decision based on the crime rate at the user's location obtained in steps 302 and 304. In various embodiments, the monitoring system 100 defaults to the standby mode, though the monitoring system 100 can take into account various data points in making the decision between standby mode and full perception mode. For example, the monitoring system 100 can default to the standby mode, though the monitoring system 100 can activate the full perception mode if the threat level is elevated above a predetermined threshold. The threat level can be based on the current location of the vehicle 102 and other environmental factors.

For example, the typical or general foot traffic in a shopping mall, park, baseball stadium, restaurant or other entity may be different than the foot traffic in a residential area. In another example, when the vehicle 102 is parked in a dark alley way the likelihood of an unusual activity is more than when the vehicle 102 is parked in a well-lit residential or commercial area. Thus, the threat level can vary depending on the location of the vehicle 102, in addition to the time of day.

The monitoring system 100 may provide the current location of the vehicle 102 to the external database 104. In response, the external database 104 may provide the corresponding location data to the monitoring system 100, which the monitoring system 100 receives. Location data can include weather conditions at a location of the vehicle. For example, cold weather can have adverse effects on the battery 130 and so the monitoring system 100 can be configured to activate standby mode if the ambient temperature is below a predetermined value (e.g., 0 deg. C.). Location data can include crime data at the location of the vehicle. Location data can include real-time traffic data. Location data can include a distance from the vehicle to a vehicle charging station. The monitoring system 100 can also use the current location of the vehicle 102 to calculate the distance from the vehicle to the vehicle charging station.

The monitoring system 100 can further take into account the current state of charge of the power source (e.g., the battery 130) of the vehicle when making a determination between standby mode and full perception mode. For example, the monitoring system 100 can activate the standby mode if the state of charge of the battery 130 is below a predetermined threshold. Conversely, the monitoring system 100 can activate the full perception mode if the vehicle 102 is plugged in and charging.

In response to determining that the threat level is below a predetermined threshold, the monitoring system 100 can activate the standby mode and initialize or activate low power sensors 114, e.g., the external ultrasonic sensors 117 (310). In various embodiments, the monitoring system 100 may only turn on the one or more ultrasonic sensors 117 in the standby mode to minimize the use of electrical energy, and then, the monitoring system 100 may turn on the one or more external cameras 116 (e.g., full perception mode) only when an unusual activity is predicted or detected. Since the vehicle is parked, the engine 128 may be off, and thus, the one or more sensors 114 may rely on electrical energy from the battery 130. As such, the monitoring system 100 may activate only low power sensors (e.g., the ultrasonic sensors 117) in the standby mode which increases energy efficiency.

Once the monitoring system 100 initializes or activates the one or more low power sensors 114, the monitoring system 100 may use the one or more sensors 114 to capture sensor data. The sensor data may be stored or buffered in the memory 110. In particular, one or more external ultrasonic sensors 117 may capture sensor data of the surrounding environment outside the vehicle 102 (312). The one or more external ultrasonic sensors 117 may be positioned on an exterior of the vehicle 102 or within the interior of the vehicle 102 but directed outward toward the surrounding environment outside the vehicle 102. Each of the one or more external ultrasonic sensors 117 may capture a different field of view or perspective of the surrounding environment outside the vehicle 102 such that together all of the one or more external ultrasonic sensors 117 may capture a 360 degree perspective view of the surrounding environment. The different data may be later stitched, merged or otherwise combined to form a panoramic field of view or perspective.

After the one or more sensors 114 begin to capture sensor data, the monitoring system 100 may buffer or store the sensor data in the memory 110. The memory 110 may reserve a set amount of memory or storage space, such as approximately 350 MB-700 MB of data, or about 30-60 minutes worth of captured sensor data in standard definition for the buffer of the sensor data. The amount of storage reserved for the captured data may be pre-determined or user-configurable and allows enough sensor data to be captured to provide a record of any unusual activities without consuming a significant amount of resources and/or capacity.

The monitoring system 100 can detect unusual activity (314) based on certain triggers. In various embodiments, the monitoring system 100 can use the external sensor data to detect unusual activity. For example, the sensor data can indicate that an object (e.g., a human) has entered into the surrounding environment of the vehicle 102. In various embodiments, the monitoring system 100 can receive communications from nearby vehicles, infrastructure, etc. (e.g., V2V, V2I, V2X, etc.) that a crime has taken place nearby, etc. For example, if the vehicle 102 is parked in its driveway and operating in standby mode, but the home security system identifies suspicious activity near the vehicle 102, the system can control the vehicle 102 to enter full perception mode. The monitoring system 100 can also control the vehicle 102 to switch back to standby mode after a predetermined period of time.

In response to detecting unusual activity, the monitoring system 100 can activate full perception mode and initialize or activate the full power sensors 114, e.g., the external cameras 116 (316). Stated differently, the monitoring system 100 can determine that the threat level is above a predetermined level in response to detecting the unusual activity with the low power sensors 114, and responsive thereto, the monitoring system 100 can activate the full perception mode and initialize or activate the external cameras 116. The monitoring system 100 may turn on the one or more external cameras 116 while the vehicle 102 is parked. In the full perception mode 208, the ultrasonic sensors 117 can also be kept on (or initialized or activated if not already on).

In various embodiments, in response to detecting unusual activity, the monitoring system 100 can send a notification to the user device 140 prompting a user to select between the standby mode or the full perception mode. In this manner, the user can decide whether full perception mode is warranted.

Once the monitoring system 100 initializes or activates the one or more cameras 116, the monitoring system 100 may use the one or more cameras 116 to capture image data.

The image data may be a single frame image and/or a multi-frame video. The single frame image and/or the multi-frame video may be stored or buffered in the memory 110. In particular, one or more external cameras 116 may capture image data of the surrounding environment outside the vehicle 102 (318). The one or more external cameras 116 may be positioned on an exterior of the vehicle 102 or within the interior of the vehicle 102 but directed outward toward the surrounding environment outside the vehicle 102. Each of the one or more external cameras 116 may capture a different image of a different perspective of the surrounding environment outside the vehicle 102 such that together all of the one or more external cameras 116 may capture a 360 degree perspective view of the surrounding environment. The different images may be later stitched, merged or otherwise combined to form a panoramic image and/or video. The sensor data among all the sensor 114 may be combined or otherwise coalesced into an image or video that captures the entire environment outside the vehicle for a time period.

After the one or more cameras 116 begin to capture image data, the monitoring system 100 may buffer or store the image data in the memory 110. The memory 110 may reserve a set amount of memory or storage space, such as approximately 350 MB-700 MB of data, or about 30-60 minutes worth of captured video recordings in standard definition for the buffer of the image data. The amount of storage reserved for the captured data may be pre-determined or user-configurable and allows enough image data to be captured to provide a record of any unusual activities without consuming a significant amount of resources and/or capacity.

The monitoring system 100 may provide the external and/or internal image data to a consumer (320). A consumer is a computing device of a person, a government agency, a business, or other entity that may use the external image data. For example, a government agency, such as the police department, may use the external image data to identify a suspect that is identified as an object that is unusual. In another example, the monitoring system 100 may provide the external image data that includes image data of the vehicle that collided with the vehicle 102 including the license plate number, make and model of the vehicle and circumstances of the accident, to an insurance company to accompany a claim. When an unidentified person interacts with the vehicle 102, the captured external image data may capture the actions of the unidentified person. The recorded information may allow for a claims adjuster or owner of the vehicle 102 to identify any lost or stolen items from within the vehicle 102. In another example, the monitoring system 100 may provide the external image data to a user or owner of the vehicle 102. For example, the monitoring system 100 may send a live, or semi-live, feed of the external cameras 116 to the user device 140 whereby the user or owner can monitor the activities in the surrounding environment of the vehicle 102, for example to determine whether the unusual activity poses a threat to the vehicle 102 or whether any additional action should be taken.

The monitoring system 100 may operate or control one or more vehicle components in response to the detecting the object that is unusual and/or action of the object that is unusual (322). The monitoring system 100 may alert and notify a third-party, such as the owner of the vehicle 102, the police or a security service provider when the unusual activity is detected, for example. The monitoring system 100 may perform other actions, such as disable the ignition, lock the doors, activate a GPS device to provide location information of the vehicle 102, close the windows, or activate an audio and/or visual alert to prevent an unidentified person from starting or gaining access to the vehicle 102.

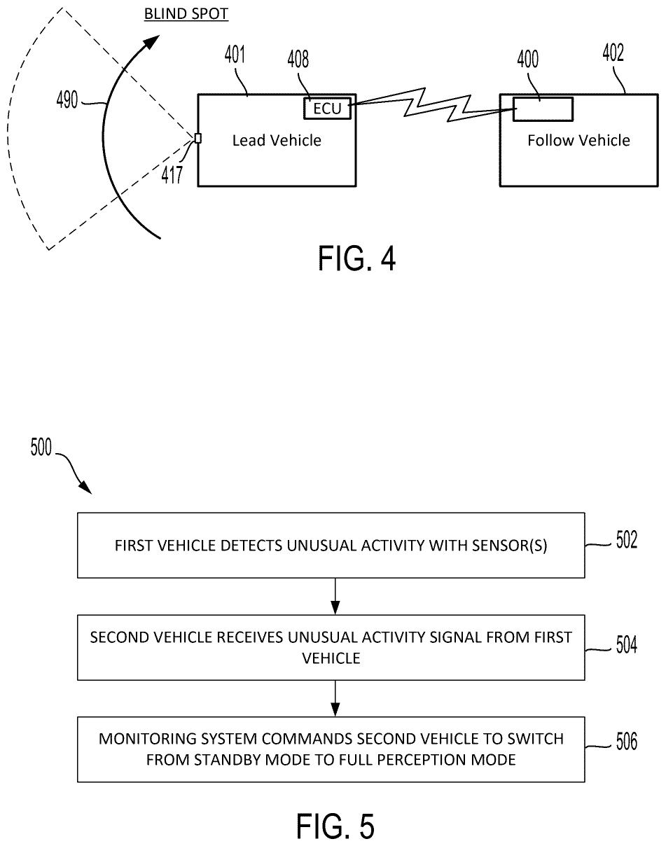

FIG. 4 is a block diagram of a lead vehicle 401 and a follow vehicle 402 having a monitoring system 400, in accordance with various embodiments. The monitoring system 400 can be similar to monitoring system 100 of FIG. 1. The follow vehicle 402 can be similar to the vehicle 102 of FIG. 1 and/or FIG. 2. The lead vehicle 401 can be similar to the vehicle 102 of FIG. 1 and/or FIG. 2. In various embodiments, the lead vehicle 401 is an internal combustion engine (ICE) vehicle and the follow vehicle 402 is an electric vehicle. The monitoring system 400 of the follow vehicle can be in communication with the ECU 408 of the lead vehicle 401. In various embodiments, the vehicles 401, 402 are connected in a hitchless towing configuration. In various embodiments, the lead vehicle 401 is a tow vehicle and the follow vehicle is a towed vehicle. The monitoring system 400 can control the vehicle with the most energy to operate in full perception mode while the second vehicle operates in standby mode. For example, where one vehicle is an electric vehicle (e.g., the follow vehicle 402) and the other vehicle is an ICE vehicle (e.g., the lead vehicle 401), the monitoring system 400 controls the ICE vehicle 401 to operate at full perception while the electric vehicle 402 operates in standby mode. If the ICE vehicle sensors (e.g., sensor 417) detect unusual activity, the monitoring system 400 can trigger the electric vehicle 402 to switch to full perception mode.

In various embodiments, if the lead vehicle 401 is incapable of sensing in a blind spot, the monitoring system 400 can automatically turn on full perception mode of follow vehicle 402 and/or request a user to manually monitor from a user device (e.g., a smart phone, tablet, etc.). For example, FIG. 4 depicts a path 490 of a suspicious object (e.g., a human) walking through a field of view of a vehicle sensor 417 and into a blind spot of the lead vehicle 401. In response to the object moving to the blind spot, the monitoring system 400 can turn on full perception mode of follow vehicle 402 to monitor movement of the suspicious object in the blind spot of the lead vehicle 401 using the vehicle sensors of the follow vehicle 402. The vehicle sensor 417 can be similar to any of external cameras 116, ultrasonic sensors 117, and/or other sensors 136 of FIG. 1.

FIG. 5 is a flow diagram of an example process 500 for monitoring vehicle surroundings. One or more computers or one or more data processing apparatuses, for example, the ECU 108 of the monitoring system 100 of FIG. 1, appropriately programmed, may implement the process 500.

The first vehicle 401 (e.g., using the ECU 408) can detect unusual activity with one or more vehicle sensors, such as sensor 417 (502). The second vehicle 402 can receive a signal from the first vehicle 401 indicating that unusual activity has been detected (504). Accordingly, the first vehicle 401 can be in communication with the second vehicle 402 (e.g., via a network as described herein). In response to receiving the signal from the first vehicle 401, the monitoring system 400 can command the second vehicle 402 to switch from standby mode to full perception mode (506).

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A monitoring system for a vehicle, comprising:
a first vehicle sensor configured to capture a first sensor data of a surrounding environment, the first vehicle sensor is configured to be powered on when the monitoring system is in a standby mode;
a second vehicle sensor configured to capture a second sensor data of the surrounding environment, the second vehicle sensor is configured to be powered on when the monitoring system is in a full perception mode and powered off when the monitoring system is in the standby mode; and
an electronic control unit coupled to the first sensor and the second sensor, and configured to:
receive location data of the vehicle; and
operate the first vehicle sensor when the vehicle is parked in the standby mode based upon the location data of the vehicle.

2. The monitoring system of claim 1, wherein the electronic control unit is further configured to:
determine whether the vehicle is parked in a predetermined location; and
in response to determining that the vehicle is parked in the predetermined location, activate the standby mode.

3. The monitoring system of claim 1, wherein the electronic control unit is further configured to:
determine whether the vehicle is parked in a predetermined location; and
in response to determining that the vehicle is not parked in the predetermined location, at least one of: (i) activate the full perception mode, or (ii) send a notification to a user device prompting a user to select between the standby mode or the full perception mode.

4. The monitoring system of claim 3, wherein the electronic control unit is further configured to:
determine a state of charge of a power source of the vehicle; and
in response to detecting the state of charge being less than a predetermined value, send the notification to the user device prompting the user to at least one of (i) select between the standby mode or the full perception mode, and (ii) charge the power source.

5. The monitoring system of claim 1, wherein the electronic control unit is configured to select between the standby mode and the full perception mode further based upon at least one of:
a weather condition at a location of the vehicle;
a state of charge of a power source of the vehicle;
a distance from the vehicle to a vehicle charging station;
a perceived level of threat at the location of the vehicle; and
a real-time traffic data.

6. The monitoring system of claim 1, wherein the first vehicle sensor includes a plurality of external sensors that are configured to capture different views of the surrounding environment outside the vehicle.

7. The monitoring system of claim 1, wherein the first vehicle sensor includes an ultrasonic sensor.

8. The monitoring system of claim 1, wherein the second vehicle sensor includes a plurality of external sensors that are configured to capture different views of the surrounding environment outside the vehicle.

9. The monitoring system of claim 1, wherein the second vehicle sensor includes a camera.

10. A method for monitoring vehicle surroundings, comprising:
receiving, by a monitoring system of a vehicle, location data indicating a current location of the vehicle;
operating the monitoring system of the vehicle based upon the location data;
in response to the location data indicating the vehicle located in a first location, operating the monitoring system in a standby mode; and
in response to the location data indicating the vehicle located in a second location, operating the monitoring system in a full perception mode.

11. The method of claim 10, wherein power consumption of the monitoring system is less in the standby mode than in the full perception mode.

12. The method of claim 10, wherein:
the operating the monitoring system in the standby mode includes powering on a first plurality of vehicle sensors and powering off a second plurality of vehicle sensors; and
the operating the monitoring system in the full perception mode includes powering on the second plurality of vehicle sensors.

13. The method of claim 10, further comprising:
detecting that the vehicle is in park; and
operating the monitoring system of the vehicle based upon the location data while the vehicle is in park.

14. The method of claim 10, wherein the location data further includes at least one of:
a weather condition at a location of the vehicle;
a state of charge of a power source of the vehicle;
a distance from the vehicle to a vehicle charging station;
a perceived level of threat at the location of the vehicle; and
a real-time traffic data.

15. The method of claim 10, further comprising:
detecting unusual activity with the monitoring system in the standby mode, and, in response thereto, at least one of:
switching from the standby mode to the full perception mode; or
sending a notification to a user device prompting a user to select between the standby mode or the full perception mode.

16. The method of claim 10, further comprising:
using one or more ultrasonic sensors when operating the monitoring system in the standby mode; and
using one or more cameras when operating the monitoring system in the full perception mode.

17. A monitoring system for a vehicle, comprising:
a vehicle sensor of a first vehicle configured to capture a sensor data of a surrounding environment of the first vehicle;
an electronic control unit coupled to the vehicle sensor and configured to:
receive surrounding environment data from a second vehicle parked adjacent the first vehicle; and
power on the vehicle sensor based upon the surrounding environment data received from the second vehicle.

18. The monitoring system of claim 17, wherein the electronic control unit is further configured to activate full perception mode of the first vehicle in response to the surrounding environment data indicating suspicious activity.

19. The monitoring system of claim 17, wherein the first vehicle is an electric vehicle and the second vehicle is an internal combustion engine vehicle.

20. The monitoring system of claim 17, wherein the second vehicle is a lead vehicle and/or a tow vehicle and the first vehicle is a follow vehicle and/or a towed vehicle.
